(19) United States
(12) Patent Application Publication
(10) Pub. No.: US 2014/0279158 A1
(43) Pub. Date: Sep. 18, 2014

(54) ARRANGING RELEVANT SERVICES FOR AN ONLINE ASSET TRANSACTION

(71) Applicant: AUCTION.COM, LLC, IRVINE, CA (US)

(72) Inventor: Robert Friedman, Laguna Hills, CA (US)

(73) Assignee: AUCTION.COM, LLC, IRVINE, CA (US)

(21) Appl. No.: 14/214,535

(22) Filed: Mar. 14, 2014

Related U.S. Application Data
(60) Provisional application No. 61/800,753, filed on Mar. 15, 2013.

(51) Int. Cl. G06Q 30/08

(52) U.S. Cl. CPC G06Q 30/08
USPC 705/26.3

(57) ABSTRACT

A method and system for arranging relevant services for an online asset transaction are described. Upon detecting an event while monitoring an auction, the system identifies services and third-party service providers within the same geographic region as the asset being auctioned that are relevant to the asset. Buyers and the seller of the asset are notified of these services and can choose to let the system manage the completion of the service by initiating and monitoring the provider's performance in carrying out a defined workflow specific to the asset.

This application claims benefit of priority to Provisional U.S. Patent Application No. 61/800,753, filed Mar. 15, 2013; the aforementioned priority application being hereby incorporated by reference in its entirety for all purposes.

### TECHNICAL FIELD

Examples described herein pertain generally to online auctions, and more specifically, to a system and method for arranging relevant services for an online asset transaction.

### BACKGROUND

A variety of online auction forums exist that enable users to transact for various kinds of items, such as collectibles, electronics, and other goods or services.

### BRIEF DESCRIPTION OF THE DRAWINGS

FIG. 1 illustrates an example system for enabling a user to arrange for and monitor services related to an auction in a networked environment.

FIG. 2A illustrates an example method for enabling a user to arrange for and monitor services related to an auction in a networked environment.

FIG. 2B illustrates an example method for enabling a workflow and communication related to services for an auction in a networked environment.

FIG. 3A illustrates a sample interface for auction users to choose services and monitor a transaction workflow related to an auction.

FIG. 3B illustrates a sample interface for auction users to track a selected provider's workflow related to an auction.

FIG. 3C illustrates a sample interface for service providers to track and update their progress in providing services to an auction user.

FIG. 4 is a block diagram that illustrates a computer system upon which embodiments described herein may be implemented.

### DETAILED DESCRIPTION

Examples described herein include a service in which relevant services in connection with an asset that is the subject of an online transaction can be programmatically facilitated for one or more parties to the transaction. Some embodiments are implemented in the context of a real-property asset transaction, such as an auction or bidding process for a home or other real-property asset. Before bidding on the auction begins, while auction is ongoing, or after the auction is complete, one or more processes may be initiated that prompt one or both parties to the transaction to engage third parties for services related to either the transaction (e.g., a home inspection report) or asset (e.g., a landscaper). The processes that are initiated can be programmatically triggered and can involve processing notifications to a party of the transaction, receiving responses from the notified parties, seeking bids for services from service providers (e.g., landscapers, carpenters, cleaners, movers, etc.), arranging such services, and/or tracking performance of the services done by the service providers.

According to some embodiments, a forum is provided for conducting an auction for an asset. The forum can be provided by a system for enabling transactions in a networked environment, such as an online auction system. The forum can enable users to participate with the auction using a computing device over one or more networks. The forum, for example, can enable a user to bid on the asset when the auction is in progress or enable a seller to monitor the auction of the asset. During the auction for the asset, the system monitors for occurrences of various auction events such as a listing being created, the start of the auction, bids being made for the auction, meeting the auction's reserve price, the end of the auction, and/or the sale of the asset being closed.

In an example, in response to detecting an auction event, a number of services related to the auction event, asset, and the geographic location of the asset are identified. Furthermore, third-party providers capable of performing the services in the geographic location of the asset within a designated distance are also identified. This provides a filtering process so that only those service providers available to provide the service and relatively nearby are selected and shown to the user, who may be the seller of the asset, the buyer of the asset, or a third party related to the asset in some other way.

According to some examples, a notification is provided to the user. The notification can invite the user to request one or more services that are related to the asset. In response to the user requesting a service, the system may solicit bids from the identified service providers capable of performing the requested service. For example, the system can send communications to the service providers requesting that they place bids for the cost of performing the service requested by the user. The service bids that are received by the system can be further provided to the user through interfaces that enable the user to select at least one of the service providers to perform each service. In addition, aggregate ratings provided by past users can be displayed to the user.

In one example, service providers for each of the user selected services are chosen automatically based on the bids entered by the service providers. For example, the user may configure settings to always choose the lowest bid for a service and skip the process of manually choosing a provider for each service.

Information about service providers that is sent to the user can be based on the type of service being arranged and the geographic location of the service providers. For example, the type of service that is identified to the user can be based on the auction event during the duration of the auction. Service providers for that type can be selected by the system based on the location of the asset, the user, and the service providers.

In an example, communications are relayed to each of the selected service providers notifying them that they have been chosen by the user to perform the requested service. This notification can trigger a workflow that may consist of a series of tasks to be performed in regards to the asset and/or the user. For example, the workflow may contain a task item for the service provider to make initial contact with the user and provide an estimate. These workflow tasks may be specific to the provider, the service, the type of user in question, and the geographic location of the asset.

In a further example, the selected service providers are monitored for their performance in carrying out the workflow. The system can track completion dates, upcoming deadlines, and scheduled dates to perform workflow items related to the user. The user may also view this tracking information to stay abreast of the progress of the service. Furthermore, the user can be prompted to submit a rating for the service provider based on the quality of work done, satisfaction of the user with the service, etc.

The terms “during an auction,” or “the duration of an auction” can refer to a duration of time that starts from the listing of an asset to be auctioned, through the bidding process and completion of the bidding process (e.g., through completion of the auction), and ends at a time during or after the closing period of the asset transaction or when the asset is finally transferred to the buyer. Examples described herein recognize that the timeline for an auction can be variable, based on auction rules. For example, an auction may implement a rule to extend the duration of the auction with the occurrence of an event such as the placement of a bid in the last minute (or other time marker) of the auction.

Still further, the term an “asset” (or variants thereof) can refer to any tangible item or product. Examples of an asset can include any item for sale, such as a vehicle, an antique, real estate property, etc. Types of real estate property can include a house, a townhouse, a condo, an apartment, a business property, land, etc.

The term a “user” (or variants thereof) can refer to a buyer, a seller, or other individuals (e.g., real estate agents, bankers, etc.) that can access a forum for an auction using a computing device.

According to some examples, an online forum is hosted in which services provided by third parties are suggested to users of the forum in order to facilitate a successful transaction or make the post-transaction period easier and more efficient. By consolidating relevant service information for an asset being sold, users and service providers are matched together to increase the likelihood of user satisfaction with the transaction and enable service providers to more easily reach customers. Tracking workflows and performance of service tasks adds transparency to the process, which may put users at ease and reduce problems between service providers and users, facilitating a turn-key transaction. In addition, by suggesting services and matching users and providers within the same forum where the asset is being sold, lower prices for higher rated providers can be extended to users.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using programmatic modules or components. A programmatic module or component may include a program, a subroutine, a portion of a program, a software component, or a hardware component capable of performing one or more stated tasks or functions. As used herein, a module or component can exist on a hardware component independently of other modules or components. Alternatively, a module or component can be a shared element or process of other modules, programs or machines.

Furthermore, one or more embodiments described herein may be implemented through the use of instructions that are executable by one or more processors. These instructions may be carried on a computer-readable medium. Machines shown or described with figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash or solid state memory (such as carried on many cell phones and consumer electronic devices) and magnetic memory. Computers, terminals, network enabled devices (e.g., mobile devices such as cell phones) are all examples of machines and devices that utilize processors, memory, and instructions stored on computer-readable mediums. Additionally, embodiments may be implemented in the form of computer programs.

System Description

FIG. 1 illustrates an example system for enabling a user to arrange for and monitor services related to an auction in a networked environment. A system 100 such as described by an example of FIG. 1 can be implemented in a variety of computing environments. For example, system 100 can be implemented as part of an online market system or environment, such as an online auction, or it can be implemented as a network service that augments or facilitates an online marketplace. Accordingly, system 100 can be implemented as a network service, through a combination of servers and/or other network-enabled computing devices. In variations, system 100 can be implemented on other computing platforms, including stand-alone systems. Thus, in some variations, system 100 can operate on a product or service that is maintained on a single computing or storage device.

In an example of FIG. 1, the components of system 100 can combine to enable services to be arranged and workflows to be tracked between a user and one or more service providers before, during, or after an auction in a network environment. In one example, system 100 includes an auction interface 110, a transaction component 120, a service management 140, a workflow management 145, and a service interface 160. System 100 can also include one or more data stores, such as an auction data store 130, a services information data store 150, and a workflow information data store 151. The components of system 100 can combine to provide communications to a user and/or one or more services providers in response to one or more auction events being detected between an auction for an asset being created by the seller and the final transfer of the asset to the buyer.

An auction interface 110 of system 100 provides a forum in which users can participate in an auction by operating user computing devices 170. Users can include potential buyers for an asset as well as sellers who have placed their assets on an online market or online auction for sale. Each user can operate a user computing device 170, such as a personal computer, laptop, tablet device, smart phone, etc., to interact with the auction interface 110. In some examples, the auction interface 110 can be implemented as part of a web page that can be displayed on display devices of the user devices 170. In other variations, the auction interface 110 can be implemented as part of an application page or presentation that can be displayed on user devices 170 and can provide functionality corresponding to the auction interface 110.

Users can interact with the auction interface 110 to view a variety of information related to the transactions of assets. Information that can be displayed through the auction interface 110 can include timing information (e.g., the time left for a bidder to submit a bid, the time left before an auction is over), minimum bid amounts for auctions, specific information about assets that are available for auctions (e.g., including images, inspection reports, appraisal reports, etc.), bid history for assets or sellers, or information about the parties.

For example, a seller of an asset, such as a real estate property, can interact with the auction interface 110 to register with the online auction system and to make the asset available to be auctioned off to the highest bidder (e.g., list the asset on the auction interface 110). The seller can also interact with the auction interface 110 to view the status of the listed asset and other information, such as information about the bidders, the current bid amount, the number of bids, how much time is remaining in the auction for the asset, etc. Similarly, a bidder can also interact with the auction interface 110 to register with the online auction system (e.g., create a user ID 113), to browse through the auctions for assets that are currently in progress (or have not yet started, have just completed, etc.), to submit one or more auction bids 111 for one or more auctions for assets (along with the bidder's user ID 113), and/or to view details about particular auctions.

A transaction component 120 can communicate with, or operate as part of, the online auction system in order to monitor one or more auctions. The transaction component 120 can maintain and/or access information for one or more auctions stored in the auction data store 130, such as when an auction is scheduled to begin, how long the auction is to be open for (e.g., when does the time period to submit a bid expire), or parameters for the completion of the auction (e.g., what conditions are required for the auction to be completed). For example, the transaction component 120 can monitor an auction for the duration of the auction, e.g., from the initial listing of an asset until the end of the closing period of the auction, in order to detect an occurrence of one or more auction events. In some examples, the closing period (e.g., in particular, for real estate transactions) can refer to a duration where the parties to the transaction consummate the purchase contract, ownership is transferred to buyer, and/or title is registered, etc., after the auction has already completed.

Depending on implementation, an auction event can include (i) a seller listing an asset for an auction (prior to the auction starting, such as in a pre-listing period), (ii) the start of the bidding period, (iii) a bid being made for the asset during the auction, (iv) a bid meeting the reserve price for the auction, (v) an auction being completed (e.g., as a result of the time for bidding expiring), or (vi) the sale for the asset being closed (e.g., closing period ends). The parties of an auction can include at least a seller of an asset and a bidder.

System 100 responds to initiating auction events by initiating workflows to provide relevant services for the bidder, buyer and/or seller. In one implementation, system 100 operates to detect an initiating auction event corresponding to the listing of an asset (which can occur days before the auction starts). In variations, the initiating auction event can be provided when the auction starts, after the auction starts but before it ends, or after the auction ends. When the transaction component 120 detects an occurrence of the auction event during the auction of the asset, the transaction component 120 can provide an auction event input 121 to the service management 140. The auction event input 121 can operate as a trigger, for example, to cause the service management 140 to initiate communication with the users or parties to the auction (e.g., the seller, the bidder) and/or with one or more service providers 180. As an addition or an alternative, the transaction component 120 can trigger the service management 140 to provide communications based on a set schedule. For example, the transaction component 120 can provide an auction event input 121 at set instances in time during the duration of the auction. In some examples, the auction event input 121 can also include information about what type of auction event was detected so that the service management 140 can determine which services to offer to the users based on the type of auction event.

The service management 140 can maintain and/or access a services information data store 150 that stores information about service types and respective service providers. For each service provider, for example, the services information data store 150 can include a service provider identifier, location information of the service provider (e.g., where the service provider has available vendors), the type of service provided, pricing information, previous user ratings and feedback for the service provider, and/or information about previous service bids made by the service provider. A service provider or vendor can refer to an individual or entity that can provide a variety of different services. For example, the online market system can correspond to transactions for real estate property, and services that are related to the sale or purchase of real estate property can include, but are not limited to, agency, property inspection, insurance services, gardening services, moving services, contractor services, landscaping, pool services, or management company services (e.g., for commercial real estate or investor real estate). In this regard, the services offered can be specific to the type of asset, such as real-estate. By way of example, if the online market system corresponds to transactions for vehicles, the services that are related to the sale or purchase of vehicles can include window jobs, car washes, mechanic services, smog checks, etc. The information provided in the services information data store 150 can also be maintained and updated by the service management 140 based on communications with service providers 180 through the service interface 160.

When the service management 140 receives an auction event input 121, the service management 140 can initiate communication(s) to be sent to the user devices 170 and/or to one or more service providers 180. In one example, a notification 141 can be generated or provided by the service management 140 that includes information about one or more services that are available for the user to request. In some implementations, the one or more services that are selected for the notification 141 can be determined based on the auction event input 121, the asset or type of asset being auctioned, and/or the geographic location of the asset.

The service management 140 can access the services information data store 150 to determine one or more services that are related to or relevant to the detected auction event (e.g., determined from the auction event input 121). For example, if the detected auction event was the seller listing a house for an auction, the service management 140 can access the services information data store 150 for services relevant to an individual selling his or her home. Such services can include, for example, a home inspection service, or an interior decorator service (e.g., to prep the house for walkthroughs and photos). Similarly, the service management 140 can determine the asset being auctioned from the auction event input 121 (e.g., a program interface message or communication), for example, to determine a service related to the asset (e.g., if the asset is a home with a pool, a pool service can be selected from the services information data store 150). In addition, the service management 140 can use the geographic location of the asset to determine services (e.g., a house in California may need an inspection for earthquake readiness, whereas one in Florida may need an inspection for hurricane readiness). Thus, the services can be specific for the type of asset (e.g., real property) and the relevant geographic location of the asset (e.g., where it is located). Furthermore, services can be tailored to the seller, who may consider such services at this particular stage of the auction process. The communication or notification 141 can be provided to the auction interface 110.

In another example, for illustrative purposes, if the detected auction event was the completion of the auction (e.g., the time period for receiving bids has ended and a highest bidder is identified), the service management 140 can access the services information data store 150 for services relevant to the detected auction event. For the winning bidder, for example, services can include movers, landscapers, or home insurance services. The service management 140 can provide communications to the winning bidder that such services can be arranged for the winning bidder. Similarly, for the seller, for example, services can include movers, or real estate agents for searching for new homes.

A user that interacts with the auction interface 110 via a user device 170 (such as the seller, in the example discussed above) can view a communication or notification 141 that invites the user to request one or more services that are available for the user (e.g., “Do you want a home inspector?”). In one example, the auction interface 110 can enable the user to provide input 171 to indicate whether or not the user would like system 100 to arrange one or more of the services for the user. In other variations, the auction interface 110 can enable the user to select and request specific services from a plurality of services. The service management 140 can receive the user selection 143 as a response to whether or not the user would like system 100 to arrange one or more of the services for the user. The user selection 143 can indicate whether or not the user would like to request a service or can specifically identify one or more particular services that the user would like to request.

In response to determining the user selection(s), the service management 140 can generate and provide a communication to one or more service providers 180 that correspond to the selected service(s). In some examples, the service management 140 can select which service providers 180 are to receive communications based on the type of service determined as well as the location information of the service providers. For example, the service management 140 can select service providers that are located within a determined distance from the location of the user and/or the location of the asset (e.g., the house that is being sold or purchased). This provides a filtering process so that only those service providers who are available and are within a geographic region to provide the service are shown to the user.

In one example, the service management 140 can generate and communicate a request 161 to one or more service providers 180 that provide services of a type requested by the user. System 100 can include a service interface 160 that enables and manages communications between system 100 and one or more devices operated by and/or associated with service providers 180. Depending on implementation, service providers 180 can operate computing devices, such as desktop computers, laptops, tablet devices, smart phones, etc., that can communicate with the service interface 160 to receive and/or send communications. Communications that are provided by system 100 can be sent to the service providers' devices as an email, a text message, part of a web page, presentation on an application running on the devices, etc.

According to an example, the service management 140 can generate (and cause the service interface 160 to provide) a bid request communication 161 in response to the user selection(s) 143. The bid request communication 161 can be a communication or message that solicits one or more service bids 163 from one or more service providers 180. A service bid 163 can identify a cost for performing the service. For example, if the user (e.g., party to the auction of an asset) selected or requested a gardening service, the service management 140 can identify one or more gardeners (e.g., service providers) that can provide the gardening service. The bid request communication 161 can be transmitted over one or more networks to one or more devices associated with the identified gardener(s) to enable the identified gardener(s) to provide a service bid 163 for their costs of performing the requested gardening services.

The service management 140 can receive the bid(s) 163 from one or more service providers and provide information corresponding to the bid(s) 163 (e.g., amount and the respective service provider(s) information) to the auction interface 110. The user can interact with the auction interface 110 to view information 117 about the service providers as well as the respective service bid(s) 163. In some examples, in response to receiving one or more service bids 163 from one or more service providers, the service interface 160 can provide the service bid(s) 163 and respective service provider information 117 to the auction interface 110.

The service management 140 can also access the services information data store 150 to determine ranking or feedback information for one or more service providers. When the service management 140 provides information corresponding to the service bid(s) 163, which includes information about a service provider and the amount for the service, the service management 140 can also provide ranking or feedback information for the respective service providers. The user can view the ranking or feedback information by interacting with the auction interface 110.

When the user interacts with the auction interface 110, the user can view the information provided (e.g., service provider information 117, bid amount, and/or feedback information, etc.) in order to select one or more service providers. The user can also interact with the auction interface 110 to place a service order for the service and/or communicate with the service provider(s). When an order is made, system 100 can provide communications to the requested service provider(s) and arrange the service for the parties. In some examples, the auction interface 110 can enable the user to communicate, via system 100, with one or more computing devices associated with the service providers. Specific order requests, the time for the service, etc., can be made via system 100. In other examples, the auction interface 110 can provide additional features (e.g., such as additional web pages) corresponding to the selected one or more service providers. Still further, the user can also receive additional contact information of the service providers.

In some examples, when a service is arranged between a party of a transaction (e.g., the user) and a service provider, system 100 can track the progress of the service through workflow management 145. Workflow management 145 can retrieve workflow information from the workflow information data store 151, which may include a checklist of workflow items 146 corresponding to the type of user, type of service, service provider, asset, and/or geographic location of the asset. The workflow items 146 can provide a programmatic internal checklist for system 100, from which task instructions can be communicated to the particular service provided on an as-needed basis. In a variation, the workflow items 146 are provided by workflow management 145 to the service interface 160 so that the selected service providers 180 can see a checklist of tasks to perform in order to complete the service to the user. The workflow items 146 can be pre-determined and specific to a type of service being provided and/or vendor.

The workflow management 145 can track individual service providers in their respective completion of individual task items 146. For example, the workflow management 145 can initiate additional communications to the party and/or the service provider requesting service status updates during the performance of the service. The communications can be provided to one or more computing devices associated with the party or the service provider 180 and also displayed on the service interface 160 and auction interface 110 so that both service providers 180 and the user can monitor the progress of the service as it is performed. In one example, in response to the service status requests, the party and/or the service provider can provide status updates while the service is on-going or provide a completion notification to workflow management 145 when the service has been completed.

Still further, some embodiments provide that the service interface 160 displays workflow items 146 and enable service providers 180 to mark workflow items 146 as completed. In addition, the service providers 180 may also enter planned dates and schedules for performing workflow items 146, which are sent to the auction interface 110 as service updates 144 so the user may track progress of the service. For example, the workflow items 146 for a landscaping company providing landscaping services for a piece of real estate may include contacting the client, arranging dates to perform the landscaping, performing landscaping on various parts of the property, an inspection, and payment. These workflow items 146 for a specific service may differ depending on the individual service provider 180, the type of asset, and/or the geographic location of the asset. Any differences in workflow items 146 can be stored in the workflow information data store 151 so that they are available to workflow management 145. This way, services can be best customized for the service provider 180, user, and the asset.

The party receiving the service can also provide a rating or feedback for the service provider once service has been completed (e.g., whenever the party wants to provide feedback or in response to system 100 requesting a feedback). The service management 140, for example, can store the ratings or feedback information for the service provider in the services information data store 150.

Depending on implementation, the service management 140 can provide communications to one or more parties to the auction and/or one or more service providers 180 simultaneously or at different times. For example, in some variations, the service management 140 can provide one or more service providers' information to a seller or bidder (or buyer) without having the user first approve or select certain services. The one or more service provider's information can be provided to the auction interface 110 in response to the occurrence of an auction event. In other examples, the service management 140 can provide, along with the one or more service provider's information, information about how much it costs for each service provider to perform the respective services, without requesting or soliciting bids from service providers. The services information data store 150 can store pricing information for services by service providers, and the service management 140 can provide the information along with the service provider's information to the auction interface 110. In another example, the service management 140 can provide a notification communication 141 and request communications 161 concurrently, in response to receiving an auction event message from the transaction component 120.

As an addition or an alternative, the service management 140 can use a checklist or mapping table, for example, to provide appropriate and relevant communications to the auction interface 110 one at a time. The checklist or mapping table can include an auction event, who is to receive a communication, and an associated set (e.g., one or more) of services and/or service providers that can provide the service. As each auction event occurs during the duration of the auction for an asset, the service management 140 can use the checklist to provide a communication to the respective parties and/or the respective service providers that corresponds to the auction event.

In this manner, during the course of an auction for an asset, services can be recommended to parties of the transaction in order to assist the parties with tasks that may need to be performed during the transaction or once the transaction is completed.

Methodology

FIG. 2A illustrates an example method for enabling a user to arrange for and monitor services related to an auction in a networked environment, according to an embodiment. While operations of an example method such as shown with FIG. 2 are described below as being performed by specific components, modules or systems of the computer system 100, it will be appreciated that these operations need not necessarily be performed by the specific components identified, and could be performed by a variety of components and modules, potentially distributed over a number of machines. Accordingly, references may be made to elements of system 100 for the purpose of illustrating suitable components or elements for performing a step or sub step being described. Alternatively, at least certain ones of the variety of components and modules described in system 100 can be arranged within a single hardware, software, or firmware component. It will also be appreciated that some of the steps of this method may be performed in parallel or in a different order than illustrated.

With reference to an example of FIG. 2A, a forum is provided on which a user may initiate an auction for an asset in a networked environment through, for example, a system 100 as described with FIG. 1 (204). The forum can enable users to participate in the auction using one or more computing devices. In one example, the forum can be provided as part of a web page that can be displayed on a computing device. In another example, the forum can be implemented as part of an application page or presentation that can be displayed on a computing device, such as a mobile phone or tablet. The seller can initiate an auction by uploading information about an asset and/or initiating an asset verification and/or intake process. For some assets such as real-property assets, the auction may go through one or more preliminary stages, such as a verification stage (e.g., where the property is verified as belonging to seller), publication stage (e.g., property made searchable and viewable for public at auction site) and auction stage (e.g., auction starts).

For an auction of an asset, the relevant participants can include the seller of the asset and one or more bidders for the asset. During the duration of the auction, transaction component 120 of FIG. 1 can monitor for auction events 121. Different auction events can be defined and utilized for different kinds of auctions and auction environments. For example, auction events can correspond to an auction being successfully completed (e.g., bid accepted by seller, bid above reserve, etc.), and/or the auction reaching the end of its time limit (208). In variations, the auction event can correspond to the asset being provided for auction by the seller (e.g., pre-auction stage) or the auction being initiated so that bids can be submitted.

Once a designated auction event 121 is detected, notifications are provided to the participants of the auction (212). According to some implementations, the notifications that are provided can relate to specific types of types services that can be arranged on behalf of one or more users of the auction. For example, a bidder or prospective bidder can be provided with a notification for bidder services (e.g., agency representation, home inspector, loan etc.), and the seller can be provided with a notification of seller services (e.g., movers). The type of services that are provided can depend on the stage of the auction (e.g., pre-auction, auction, post-auction). The notifications can invite the participant to request or select one or more of the available services (e.g., “Do you want a pool cleaner?”). These services may be selected based on various selection parameters, such as the particular auction event that is detected, the type of user (e.g. bidder or prospective bidder or seller), the type of asset, and/or the asset's geographic location. In some examples, the detected auction event 121 can correspond to a certain stage in the auction process.

Examples recognize that certain services may be of importance to one or more participants based on the stage of the auction process. For example, the seller of a real estate property may wish to arrange for an open house before the bidding period begins. In addition, the notifications that are provided can also relate to the asset or asset type that is being auctioned (e.g., different services will be offered for a car and a house). In one embodiment, these notifications 141 are generated by service management 140 and can be viewed on the auction interface 110 by user devices 170. Furthermore, notifications 141 can also be transmitted to users via e-mail, SMS, application alerts, etc. Along with the notification 141, service management 140 will request that the user select one or more services to be performed. If the user chooses not to select a service, the system 100 will continue monitoring for further auction events 121, in one embodiment.

Otherwise, if the user does select at least one service, the user selection 143 can be sent from the auction interface 110 to service management 140 (216). Based on the selected services or type of services, the service management 140, for example, can determine one or more service providers that can provide the selected service, such as by using information in the services information data store 150. This determination can be made using the types of services the service providers perform, the geographic location of the service providers, and any other requirements that may have been specified.

In one example, service management 140 can solicit bids by providing a bid request communication 161 to the relevant service providers that have been determined to be able to perform the service the user requested (217). This bidding process, in one embodiment, may request all relevant service providers to secretly place bids 163. In another embodiment, the service providers may be able to see the other bids 163 and attempt to provider cheaper service so that they are ultimately selected by the user. The bidding process may also be executed as a form of auction, such as a reverse auction. In one example, service providers 160 place their bids 163 using service interface 160, which may communicate the bids 163 to service management 140.

In other examples, the service management 140 can solicit bids or request information about how much a service costs at a previous time and then use this information rather than soliciting new bids in response to the user selection 143 (218). This pricing information can be stored in the services information data store 150, and the service management 140 can retrieve the pricing information without having to transmit a bid request communication 161 to the service providers 180. This may be preferable for services in which the price is easily computed or rarely changes, and it can reduce the amount of time between when a user requests a service and when that user receives pricing information. In other embodiments, the notification 141 presented to the user can be sent to the respective service providers concurrently instead of waiting for a user selection 143.

In one implementation, service management 140 can provide the bids or pricing information for the service providers 180 to the user as part of the auction interface 110 or via other communication methods (220). The auction interface 110 enables the user to view all the service providers 180 that responded to the user selection 143 for services, or in one example, all service providers 180 that meet matching criteria in the services information data store 150. At this point, a user may choose one or more providers for each of the previously requested services, or the user may choose not to enter into a relationship with any of them. In one example, a user can contact the service providers 180 to ask questions and obtain more information before selecting a provider. If the user chooses not to select any service providers 180, the system 100 will continue monitoring for further auction events 121, in one embodiment.

On the other hand, if a user does make a selection of at least one service provider 180 (e.g., from the auction interface 110), service management 140 can receive the user selection 143 (224). For example, if a user had requested landscaping services for a real estate property, the user's selection 143 will be for a specific landscaping company chosen based on the provider information 117 previously relayed to the user.

In another embodiment, rather than wait for the user to make a selection, service management 140 can be configured to automatically select a service provider 180 for each requested service on behalf of the user (228). For example, a user can enter constraints (e.g., from the auction interface 110) on desired providers, price ranges, etc., which may be saved in the services information data store 150. This way, regular users such as brokers and real estate companies can expedite the arrangement of services for assets they may be buying or selling rather than having to manually select providers for each asset.

Once providers have been chosen by the user, service management 140 sends requests 161 on behalf of the user to service providers 180 to initiate a workflow, in one example (232). Furthermore, service management 140 can communicate with workflow management 145 to arrange for workflow items 146 to be sent to service providers 180. Using the type of service, asset, geographical location of the asset, and the service provider, workflow management 145 can retrieve corresponding workflow items 146 from the workflow information data store 151 relevant to the service being requested. Such workflow items 146 may be, for an example landscaping company, a checklist including contacting the client, arranging dates to perform service, landscaping the front and back yard of the property, an inspection, and payment. These workflow items 146 may be displayed on the service interface 160, and in other embodiments, communicated to the service providers 180 via other methods. In addition, the workflow items 146 can be made available to users on the auction interface 110 or through other means, such as e-mail, SMS, or application updates.

In one example, after service providers 180 are sent workflow items 146, workflow management 145 continues to monitor service providers' performance (236). For example, when a service provider 180 completes one of the workflow items 146, the service provider 180 can mark that item as completed on service interface 160, which is sent as a workflow update 147 to be processed by workflow management 145. This update can also be sent to the auction interface 110 where it may be viewed by the user, in one embodiment. For example, after a landscaping company completes landscaping on the front lawn for a user, the company can use service interface 160 to mark the front lawn workflow item 146 as completed, which the user may view on the auction interface 110. This way, the user can track the current progress of the service as its being performed. In addition, in one embodiment, workflow management 145 can track missed deadlines, alert providers and users, and keep statistics on performance in the services information data store 150. For example, if a company is remiss on providing service, the system 100 can inform the user of potential solutions or steps to take or, in one embodiment, attempt to seek an automated resolution through the service provider 180.

FIG. 2B illustrates an example method for enabling a workflow and communication related to services for an auction in a networked environment. With reference to an example of FIG. 2B, service providers 180 of FIG. 1 can be notified of a user selection 143 to perform a requested service (254). This notification, in some embodiments, is provided on the service interface 160 and may also be communicated via other means, such as e-mail, SMS, or an application alert. In one example, details relating to the asset are sent to the service providers 180 along with the notification (258). Such details may include the location of the asset (259) and a workflow checklist of workflow items 146 generated by workflow management 145 (260).

In one example, workflow management 145 and service management 140 inform the user of the service status throughout the process until the service has been completed satisfactorily (262). In one embodiment, workflow updates 147 are entered by service providers 180 (e.g., on the service interface 160) and displayed to users on the auction interface 110. Along with this information, the auction interface 110 can also enable the user to make contact with the provider, for example to ask questions, arrange dates, cancel service, lodge complaints, etc. (266).

Furthermore, during and after the performance of the service, the user may enter a rating for the service provider 180 representing how satisfied the user was with the service performed (270). This rating, in an embodiment, may be stored and averaged with other ratings in the services information data store 150 to enable future users to pick service providers 180 with superior performance. In addition, a user may also be able to leave comments and other notes along with the rating.

### EXAMPLES

FIG. 3A illustrates a sample interface 300 for auction users to choose services and monitor a transaction workflow related to an auction. In the example provided, the auction interface 110 displays basic auction data identifying the asset such as the address, a unique event identifier, a picture of the asset, and the current status of the transaction.

In addition, the service interface 160 illustrated displays a selectable list of services relevant to the user's transaction with the asset. In this example, a buyer is closing on a house and may wish to arrange for various services such as property inspection, insurance, landscaping, or movers. In one embodiment, when the user selects an available service, a list of companies capable of providing that service are then displayed along with pricing information and ratings. The user may select any of the service providers and initiate a request for service through the service user interface.

Furthermore, the interface may also contain a transaction checklist for the asset detailing services important to the user's transaction with the asset. In this example, the interface displays a checklist informing the user that he or she should consider having an inspection, acquiring insurance, contracting with a landscaping company, movers, and having utilities turned on. In some embodiments, this transaction checklist is managed by the system 100 and will automatically update as services are performed by service providers 180. Alternatively, users can manually update the checklist if, for example, services were performed outside of the system.

FIG. 3B illustrates a sample interface 350 for auction users to track a selected provider's workflow related to an auction. The workflow provided for each type of provider can be specific to the type of services or providers. Furthermore, with selection of a particular provider, the user may be provided additional options in order to solicit bids or choose a specific provider. When the selected provider is known or determined, some or all of the workflow for the provider can be communicated to both the customer and the service provider.

In the example provided, a home buyer has contracted with a landscaping provider named Company A to perform landscaping on a home, currently in closing. The workflow items of contacting the client, arranging dates to perform service, and landscaping the front lawn have already been completed, and landscaping the rear lawn, inspecting the work, and payment are scheduled to be done later. In this example, the transaction checklist detailing services important to the user's transaction with the asset is also displayed on this interface. In addition, the user may contact Company A through the interface, for instance to report a problem with service or change a date. In one embodiment, the user can also provide a rating of the provider indicating the user's satisfaction with the work performed.

FIG. 3C illustrates a sample interface 375 for service providers to track and update their progress in providing services to an auction user. In the example provided, the service provider is a landscaping company performing landscaping on a property. The customer address is displayed along with a method of contacting the customer. In addition, the system 100 displays a workflow checklist of workflow items 146 to be performed for the customer. In this example, the landscaping company has already contacted the client, arranged dates to perform service, and landscaped the front lawn. Landscaping the rear lawn, an inspection, and payment are unchecked and therefore have not yet been performed, but do contain scheduled dates. The workflow for the particular provider can be specific for the type of services provided and/or the geographic location of the provider (or asset).

Computer System

FIG. 4 is a block diagram that illustrates a computer system upon which examples described herein may be implemented. For example, in the context of FIG. 1, system 100 may be implemented using a computer system such as described by FIG. 4. System 100 may also be implemented using a combination of multiple computer systems as described by FIG. 4.

In one implementation, computer system 400 includes processing resources 410, main memory 420, ROM 430, storage device 440, and communication interface 450. Computer system 400 includes at least one processor 410 for processing information. Computer system 400 also includes a main memory 420, such as a random access memory (RAM) or other dynamic storage device, for storing information and instructions to be executed by the processor 410. Main memory 420 also may be used for storing temporary variables or other intermediate information during execution of instructions to be executed by processor 410. Computer system 400 may also include a read only memory (ROM) 430 or other static storage device for storing static information and instructions for processor 410. A storage device 440, such as a magnetic disk or optical disk, is provided for storing information and instructions.

The communication interface 450 can enable the computer system 400 to communicate with one or more networks 480 (e.g., cellular network) through use of the network link (wireless or wireline). Using the network link, the computer system 400 can communicate with one or more computing devices and/or one or more servers. In some variations, the computer system 400 can provide one or more communications to a user or service providers. For example, the computer system 400 can (i) provide one or more notifications 452 and/or bid solicitation requests, and (ii) receive bids 456 from service providers and/or user selection 456 of service providers to and from one or more computing devices (e.g., belonging to users and service providers, respectively) via the network link. The received bids 454 and user selections 456 can be processed by the processor 410 and can be stored in, for example, the storage device 440.

Computer system 400 can also include a display device 460, such as a cathode ray tube (CRT), an LCD monitor, or a television set, for example, for displaying graphics and information to a user. An input mechanism 470, such as a keyboard that includes alphanumeric keys and other keys, can be coupled to computer system 400 for communicating information and command selections to processor 410. Other non-limiting, illustrative examples of input mechanisms 470 include a mouse, a trackball, touch-sensitive screen, or cursor direction keys for communicating direction information and command selections to processor 410 and for controlling cursor movement on display 460.

Examples described herein are related to the use of computer system 400 for implementing the techniques described herein. According to one example, those techniques are performed by computer system 400 in response to processor 410 executing one or more sequences of one or more instructions contained in main memory 420. Such instructions may be read into main memory 420 from another machine-readable medium, such as storage device 440. Execution of the sequences of instructions contained in main memory 420 causes processor 410 to perform the process steps described herein. In alternative implementations, hard-wired circuitry may be used in place of or in combination with software instructions to implement examples described herein. Thus, the examples described are not limited to any specific combination of hardware circuitry and software.

It is contemplated for examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the examples are not limited to those precise descriptions and illustrations. As such, many modifications and variations will be apparent to practitioners. Accordingly, it is contemplated that a particular feature described either individually or as part of an example can be combined with other individually described features, or parts of other examples, even if the other features and examples make no mentioned of the particular feature.

What is claimed is:

1. A method of providing services in connection with an auction, the method being performed by one or more processors and comprising:
monitoring an auction for one or more types of auction events, the auction being provided for an asset that has a geographic location;
upon detecting an auction event, identifying a plurality of services and one or more service providers for each of the plurality of services, wherein at least some of the one or more service providers for one or more of the plurality of services are within a designated distance from the geographic location of the asset;
providing a notification to the user, the notification including content that identifies the plurality of services;
based on a user response to the notification, providing the user with one or more interfaces to select individual services and individual service providers;
sending a communication to each selected service provider to initiate a workflow for performing a task or series of tasks for the asset; and
monitoring the selected service providers' performance of the workflow.

2. The method of claim 1, wherein providing the user with one or more interfaces includes (i) prompting the user to request one or more of the plurality of services, and (ii) sending a communication to one or more of the service providers for each of the selected services to request a bid for performing the service.

3. The method of claim 2, further comprising automatically selecting the service provider for one or more of the plurality of services based on the bid provided by the service provider.

4. The method of claim 2, further comprising enabling the user to select the service provider for one or more of the plurality of services.

5. The method of claim 1, further comprising determining the workflow for one or more service providers based on the service and/or the geographic location of the asset.

6. The method of claim 1, wherein the workflow for performing the task includes a workflow item in which the service provider is to make initial contact with the user or provide an estimate to the user.

7. The method of claim 1, wherein the one or more types of auction events comprise at least one of listing the asset for auction, the start of the auction, a bid being made for the auction, meeting a reserve price for the auction, the end of the auction, and the sale of the asset being closed.

8. The method of claim 1, further comprising enabling the user to communicate with the selected service providers.

9. The method of claim 1, further comprising:
presenting a current rating to the user for the one or more service providers; and
enabling the user to submit a rating for the selected service providers.

10. The method of claim 1, wherein the user is the seller of the asset.

11. The method of claim 1, wherein the user is the buyer of the asset.

12. The method of claim 1, wherein the asset is a real estate property, and wherein the plurality of services comprises at least one of property inspection, insurance services, gardening services, moving services, contractor services, landscaping, pool services, and management company services.

13. A system comprising:
one or more network interfaces;
one or more memory resources; and
one or more processors coupled to the one or more network interfaces and the one or more memory resources, the one or more processors to:
monitor an auction for one or more types of auction events, the auction being provided for an asset that has a geographic location;
upon detecting an auction event, identify a plurality of services and one or more service providers for each of the plurality of services, wherein at least some of the one or more service providers for one or more of the plurality of services are within a designated distance from the geographic location of the asset;
provide a notification to the user, the notification including content that identifies the plurality of services;
based on a user response to the notification, provide the user with one or more interfaces to select individual services and individual service providers;
send a communication to each selected service provider to initiate a workflow for performing a task or series of tasks for the asset; and
monitor the selected service providers' performance of the workflow.

14. The system of claim 1, wherein providing the user with one or more interfaces includes (i) prompting the user to request one or more of the plurality of services, and (ii) sending a communication to one or more of the service providers for each of the selected services to request a bid for performing the service.

15. The system of claim 14, wherein the one or more processors automatically select the service provider for one or more of the plurality of services based on the bid provided by the service provider.

16. The system of claim 14, wherein the one or more processors enable the user to select the service provider for one or more of the plurality of services.

17. The system of claim 1, wherein the one or more processors determine the workflow for one or more service providers based on the service and/or the geographic location of the asset.

18. The system of claim 1, wherein the workflow for performing the task includes a workflow item in which the service provider is to make initial contact with the user or provide an estimate to the user.

19. The system of claim 1, wherein the one or more types of auction events comprise at least one of listing the asset for auction, the start of the auction, a bid being made for the auction, meeting a reserve price for the auction, the end of the auction, and the sale of the asset being closed.

20. A non-transitory computer-readable medium storing instructions that, when executed by one or more processors, cause the one or more processors to:
monitor an auction for one or more types of auction events, the auction being provided for an asset that has a geographic location;
upon detecting an auction event, identify a plurality of services and one or more service providers for each of the plurality of services, wherein at least some of the one or more service providers for one or more of the plurality of services are within a designated distance from the geographic location of the asset;
provide a notification to the user, the notification including content that identifies the plurality of services;
based on a user response to the notification, provide the user with one or more interfaces to select individual services and individual service providers;
send a communication to each selected service provider to initiate a workflow for performing a task or series of tasks for the asset; and
monitor the selected service providers' performance of the workflow.
